(19) United States
(12) Patent Application Publication
(10) Pub. No.: US 2025/0333123 A1
(43) Pub. Date: Oct. 30, 2025

(54) AUTOMATIC COUPLING SYSTEM

(71) Applicant: R.A. PHILLIPS INDUSTRIES, INC., Irvine, CA (US)

(72) Inventors: Daniel William Forthoffer, Birmingham, MI (US); Lee Foster Hovey, IV, Lowell, MI (US); Jonathon Boyd, Loveland, CO (US); Kenneth Orr, Holland, MI (US)

(21) Appl. No.: 19/192,267

(22) Filed: Apr. 28, 2025

Related U.S. Application Data
(60) Provisional application No. 63/639,108, filed on Apr. 26, 2024.

(51) Int. Cl. B62D 53/12; B62D 53/08

(52) U.S. Cl. CPC B62D 53/125; B62D 53/0807

(57) ABSTRACT

A fine-alignment coupling system for coupling a trailer and a towing vehicle includes a housing including a first plate and a second plate coupled to one another; a connector carriage within the housing and configured to move relative to the housing along a first direction, the connector carriage including: a first connector head including a plurality of electrical connection terminals and a pneumatic terminal; and an actuator fixedly coupled to the housing and configured to move the connector carriage relative to the housing along the first direction.

### CROSS-REFERENCE TO RELATED APPLICATION(S)

This application claims priority to, and the benefit of, U.S. Provisional Application No. 63/639,108 (“AUTOMATIC COUPLING SYSTEM”), filed on Apr. 26, 2024, the entire content of which is incorporated herein by reference.

### FIELD

Aspects of the present disclosure relate to trailer coupling systems.

### BACKGROUND

Generally, in order for a motorized vehicle to tow a trailer, there is a connection methodology that allows the trailer to rotate to a certain extent both vertically and horizontally in relation to the motorized vehicle while towing the trailer through the use of a hitch, fifth wheel, or other apparatus. This hitch, fifth wheel, or other apparatus with similar functionality is used to connect and disconnect the trailer from the motorized vehicle as well as maintain the connection between the motorized vehicle to the trailer during most, if not all, of the circumstances encountered while the motorized vehicle is towing the trailer.

Commonly, the towing vehicle has a coupling plate known as a fifth wheel, which is bolted to its rear chassis or frame, on which the trailer rests and pivots. When the towing vehicle reverses under the trailer, a kingpin under and near the front side of the trailer slides into a slot in the fifth wheel and is locked in place as the clamps of the fifth wheel close onto it. This secures the trailer to the towing vehicle while allowing limited relative motion between the two.

In addition to establishing a physical connection between the towing vehicle and trailer, a number of connections are initiated and maintained between the two, which allow the electrical and mechanical systems within the trailer to operate while being towed. These connections may include electrical, pneumatic, and other connections. The electrical connections may operate and obtain feedback from lights, braking systems, electronic control systems, telematics systems, backup warning systems, lane keeping and departure systems, camera systems and the like. The pneumatic connections may operate and obtain feedback from braking systems, connector blow-off systems, tire pressure maintenance systems, cooling systems and others. Other types of connections that may exist between the towing vehicle and trailer may include, for example, hydraulic connections, rotational (PTO) connections, and/or the like.

Once the trailer is physically coupled to the towing vehicle via a hitch, the fifth wheel, or other apparatus, the driver then manually couples the airbrake lines and electrical cables. The need for human intervention for coupling towing vehicles and trailers makes existing coupling solutions unsuitable for autonomous systems.

The above information disclosed in this Background section is only for enhancement of understanding of the background of the invention and therefore it may contain information that does not form the prior art that is already known to a person of ordinary skill in the art.

### SUMMARY

Aspects of embodiments of the present invention are directed to an auto-coupling system for automatically aligning electrical, pneumatic, and other connections between a towing vehicle and a trailer without human intervention. The auto-coupling system includes a coarse-alignment coupling system and a fine-alignment coupling system that are coupled to the towing vehicle. During a coupling maneuver, the coarse-alignment coupling system, which has an extendable arm, brings the fine-alignment coupling system within close proximity to the receiving connector head of the trailer. At that point, the fine-alignment coupling system drives a connector head containing electrical terminals and pneumatic fittings to establish precise alignment and connection with the trailer's corresponding connector. The fine-alignment coupling system also includes alignment wheels for precise positioning and a locking mechanism to secure the connection.

According to some embodiments of the present disclosure, there is provided a fine-alignment coupling system for coupling a trailer and a towing vehicle, the fine-alignment coupling system including: a housing including a first plate and a second plate coupled to one another; a connector carriage within the housing and configured to move relative to the housing along a first direction, the connector carriage including: a first connector head including a plurality of electrical connection terminals and a pneumatic terminal; and an actuator fixedly coupled to the housing and configured to move the connector carriage relative to the housing along the first direction.

In some embodiments, the housing is coupled to an arm of a coarse-alignment coupling system of the towing vehicle.

In some embodiments, the first and second plates of the housing are parallel to one another and define an accommodation space therebetween configured to accommodate the connector carriage, and the first and second plates are fixedly connected to a backplate and sidewalls of the housing via a plurality of fasteners.

In some embodiments, the connector carriage includes a slide rail attached to a body of the connector carriage and a linear slide bearing coupled to the housing, and the slide rail is configured to slide through the linear slide bearing and to enable linear motion of the connector carriage within the housing.

In some embodiments, the first connector head is configured to mate with a second connector head at the trailer and to establish an electrical and pneumatic connection between the towing vehicle and the trailer.

In some embodiments, the first connector head further includes: an ethernet terminal configured to establish ethernet connection between the towing vehicle and the trailer.

In some embodiments, the plurality of electrical connection terminals are connected to an electrical connector from the towing vehicle, and the pneumatic terminal is connected to a pneumatic hose from the towing vehicle.

In some embodiments, the fine-alignment coupling system further includes a locking mechanism configured to lock the connector carriage to the housing at a lock position in response to a set displacement of the connector carriage relative to the housing.

In some embodiments, the locking mechanism includes a lock lever that is spring-loaded to be retracted in response to the connector carriage not being in the lock position, and the lock lever is configured to engage an opening in the housing in response to the set displacement of the connector carriage relative to the housing.

In some embodiments, the connector carriage includes a sliding track extending along a sidewall of the connector carriage, and the locking mechanism includes a slide follower coupled to the lock lever and configured to move along the sliding track.

In some embodiments, the actuator is linear actuator that is pneumatically activated.

In some embodiments, the actuator has an internal chamber configured to receive, and to expand in response to, pressurized air from the towing vehicle, and the actuator further includes a piston configured to apply a force to a back plate of the connector carriage to move the connector carriage in the first direction in response to expansion of the internal chamber.

In some embodiments, the fine-alignment coupling system further includes: a first alignment wheel rotatably coupled between the first and second plates and configured to roll against a guide track at a front surface of the trailer facing the towing vehicle.

In some embodiments, the fine-alignment coupling system further includes: a second alignment wheel rotatably coupled between the first and second plates at of the housing and configured to roll against the guide track, and the first and second alignment wheels are at a first corner and a second corner of the housing, respectively.

According to some embodiments of the present disclosure, there is provided an auto-coupling system including: a coarse-alignment coupling system coupled to a towing vehicle and including: a base mounted to a fifth wheel of the towing vehicle or a vehicle frame under the fifth wheel of the towing vehicle; and a moveable arm movably coupled to the base; and a fine-alignment coupling system coupled to an end of the moveable arm and including: a housing including a first plate and a second plate coupled to one another; a connector carriage within the housing and configured to move relative to the housing along a first direction, the connector carriage including: a first connector head including a plurality of electrical connection terminals and a pneumatic terminal; and an actuator fixedly coupled to the housing and configured to move the connector carriage relative to the housing along the first direction.

In some embodiments, in response to the towing vehicle performing a coupling maneuver with a trailer, the coarse-alignment coupling system is configured to bring the fine-alignment coupling system in close proximity to a second connector head of the trailer, and the fine-alignment coupling system is configured to bring the first connector head in contact with the second connector head.

In some embodiments, the first connector head is connected to first electrical and pneumatic conduits from the towing vehicle, and the second connector head is connected to second electrical and pneumatic conduits of the trailer.

In some embodiments, the fine-alignment coupling system further includes: a first alignment wheel rotatably coupled between the first and second plates and configured to roll against a sliding track at a front surface of the trailer facing the towing vehicle.

In some embodiments, the plurality of electrical connection terminals are connected to an electrical connector from the towing vehicle, and the pneumatic terminal is connected to a pneumatic hose from the towing vehicle.

In some embodiments, the fine-alignment coupling system further includes: a locking mechanism configured to lock the connector carriage to the housing at a lock position in response to a set displacement of the connector carriage relative to the housing.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be illustrative only.

FIG. 1A illustrates a perspective view of the auto-coupling system mounted under a fifth wheel of a towing vehicle, according to some example embodiments of the present disclosure.

FIG. 1B illustrates a side view of the auto-coupling system, according to some example embodiments of the present disclosure.

FIGS. 2A, 2B, 2C, and 2D respectively illustrate a perspective view, a top view, a front view, and a side view of the fine-alignment connector system, according to some example embodiments of the present disclosure.

FIGS. 3A and 3B respectively illustrate the fine-alignment connector system in a disengaged state and an engaged state, according to some example embodiments of the present disclosure.

FIG. 4A illustrates a partial perspective view of the carriage body of the the fine-alignment connector system, according to some embodiments of the present disclosure.

FIG. 4B illustrates a perspective view of the sliding mechanism of the fine-alignment coupling system, according to some embodiments of the present disclosure.

FIGS. 4C, 4D, and 4E respectively illustrate perspective views of a lock lever of a locking mechanism of the fine-alignment connector system, a spring of the locking mechanism, and a side panel of the housing of the fine-alignment connector system, according to some embodiments of the present disclosure.

FIGS. 5A and 5B illustrate perspective exposed views of the connector carriage in a disengaged/unlocked position and in an engaged/locked position, respectively, according to some embodiments of the present disclosure.

FIGS. 6A and 6B illustrate a front side perspective view and a rear side perspective view of the a first connector head of the fine-alignment connector system, according to some embodiments of the present disclosure.

### DETAILED DESCRIPTION

The detailed description set forth below in connection with the appended drawings is intended as a description of illustrative embodiments of a an auto-coupling system in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention. As denoted elsewhere herein, like element numbers are intended to indicate like elements or features.

Aspects of embodiments of the present invention are directed to an auto-coupling system for automatic alignment of electrical, pneumatic, and other connections used to facilitate the coupling of a motorized vehicle to a trailer, without human intervention. As a towing vehicle backs into a trailer to engage and lock the kingpin of the trailer with the fifth wheel of the towing vehicle, an adjustable arm of the auto-coupling system automatically brings the connector head of the towing vehicle in close proximity to the corresponding connector head of the trailer to allow the two connector assemblies to make contact and couple the electrical, pneumatic, and other connections of the towing vehicle to those of the trailer. As such, the electrical and pneumatic connections may be established without human intervention. This makes the auto-coupling system particularly suitable to autonomous driving/hauling solutions that do not involve a human driver.

As used herein a towing vehicle refers to any implement incorporating a fifth wheel style trailer hitch that is capable of pulling another implement without its own ability to propel itself. Examples of towing vehicles include semi-tractors, terminal tractors, pickup trucks equipped with a fifth wheel hitch, autonomous vehicles equipped with a fifth wheel hitch, and the like. Further, a trailer refers to any implement (e.g., any unpowered implement) designed to be connected to a fifth wheel hitch assembly for the sole purpose of towing, and which includes a kingpin mounted to its underside. Examples of trailers include dry van trailers, flat bed trailers, tanker trailers, chassis trailers, camper trailers, some farm implements, and the like.

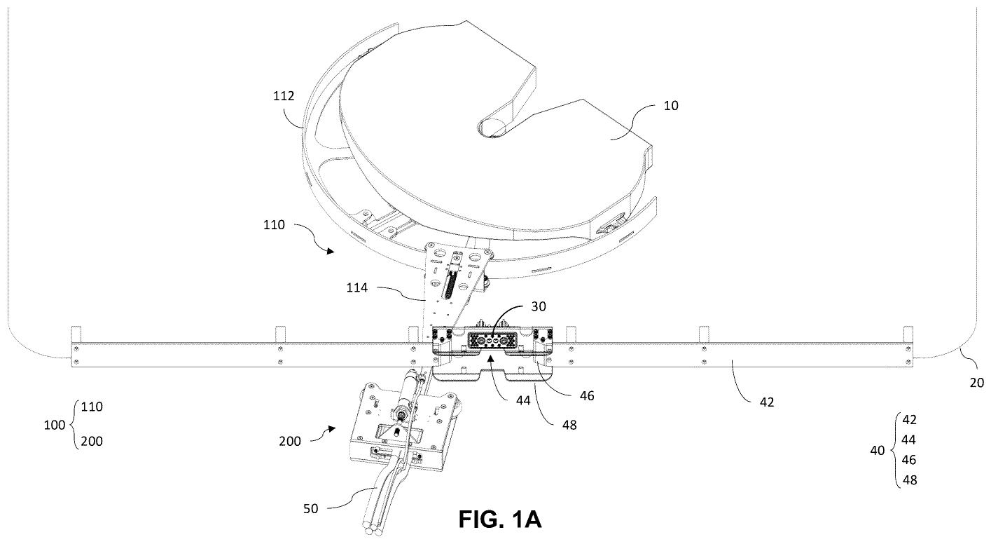

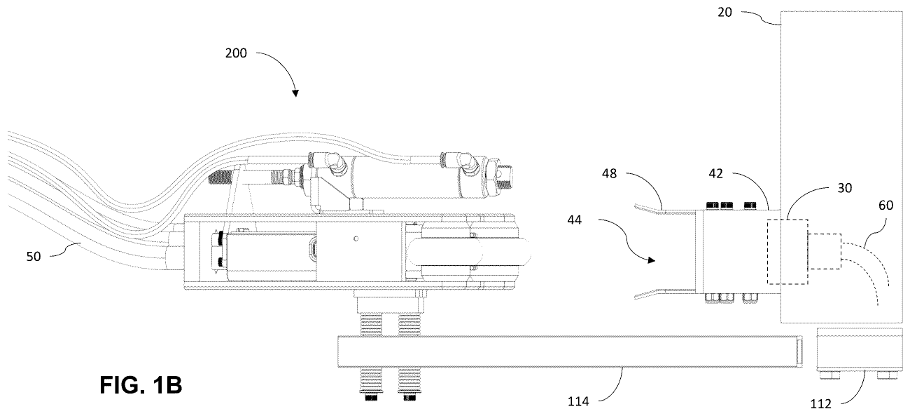

FIG. 1A illustrates a perspective view of the auto-coupling system 100 mounted under a fifth wheel 10 of a towing vehicle, according to some example embodiments of the present disclosure. FIG. 1B illustrates a side view of the auto-coupling system 100, according to some example embodiments of the present disclosure.

Referring to FIGS. 1A-1B, the auto-coupling system 100 is mounted to the towing vehicle and is configured to automatically connect (i.e., without human intervention) the electrical and pneumatic conduits of the towing vehicle with those of the trailer 20 when the towing vehicle performs a coupling maneuver with the trailer 20.

According to some embodiments, the auto-coupling system 100 includes a coarse-alignment assembly 110 and a fine-alignment assembly 200 (also referred to as coarse-alignment coupling system and a fine-alignment coupling system, respectively).

The coarse-alignment assembly 110 may include a base 112 coupled to (e.g., mounted to) a fifth wheel 10 and/or a vehicle frame under the fifth wheel 10 of the towing vehicle and an extendable arm 114 that moveably couples (e.g., rotatably couples) the base to a fine-alignment connector 122 of the fine-alignment assembly 200. The extendable arm 114 is configured to extend in response to the relative movement of the towing vehicle and trailer 20. In some examples, the extendable arm 114 may extend from about 70 cm to about 120 cm to account for different kingpin positions relative to the front of the trailer 20 and the wide range of angular orientations between the towing vehicle and the trailer 20.

The fine-alignment assembly 200 includes a first connector head (e.g., a fine-alignment or tractor-side connector head) that is configured to mate with a second connector head (e.g., a receiving or trailer-side connector head) 30, which resides at (e.g., is affixed to) the front surface of the trailer 20. The first connector head is connected to first electrical and pneumatic conduits 50 from the towing vehicle, and the second connector head 30 is connected to second electrical and pneumatic conduits 60 of the trailer 20 (see, e.g., FIG. 1B).

In some embodiments, the fine-alignment connector 122 is connected to an end of the extendable arm 114 that extends away from the trailer 20, and is configured to move against an outer perimeter of the trailer 20.

In some examples, a guiding member 40 is mounted to the front-side (i.e., a side facing the towing vehicle) of the trailer 20 that guides the fine-alignment coupling system toward the second connector head 30 of the trailer 20 (which may also be referred to as a receiving connector of the trailer 20). The guiding member 40 may include a guide track (e.g., a bump stop) 42 that extends horizontally along the front side of the trailer 20 and has an opening 44 defined by (e.g., horizontally defined by) two tapered or rounded edges 46. The opening 44, which may be near a center of the front face of the trailer 20, is configured to accommodate (e.g., house) the second connector head 30 of the trailer 20. The guiding member 40 may also include two guide plates 48 above and below the opening 44 that define the opening 44 vertically. The top and bottom plates may be bent outward away from the second connector head 30.

In some embodiments, during the automatic coupling process, the fine-alignment coupling system 200 may roll along the guide track 42 and be horizontally guided to the trailer connector head via the tapered or rounded edges 46 of the opening 44, and may be vertically guided to the second connector head 30 via one or more of the outwardly bent top and bottom plates 48.

Thus, when a towing vehicle backs into the trailer 20 to engage the kingpin of the trailer 20 with the fifth wheel and to couple the vehicle to the trailer 20, the auto-coupling system 100 is capable of bringing the fine-alignment coupling system 200 in close proximity to, and in alignment with, the second connector head 30. In some examples, the auto-coupling system 100 may bring the fine-alignment coupling system 200 and the second connector head 130 to within about 1 cm to about 5 cm of one another. At that point, actuation/engagement mechanisms equipped with the fine-alignment coupling system 200 may mate its connector head with that of the trailer (e.g., by fully seating the connector head of the fine-alignment coupling system 200 within a receptacle of the receiving connector 30) to establish the electrical and pneumatic connection between the towing vehicle and the trailer 20.

The auto-coupling system 100 is capable of ensuring proper alignment of the connector heads of the fine-alignment system and trailer not just when a towing vehicle backs straight into the trailer 20, but also during coupling maneuvers that are executed from a vehicle-trailer angle of approach (also referred to as an engagement angle) of about −45 degrees and about 45 degrees. This allows the auto-coupling system 100 to be used in environments, such as ports or rail yards, where trailers may be closely parked back-to-back in order to save space, and where it is common to have to perform a coupling maneuver while at a 45 degree angle relative to the trailer 20. This is particularly desirable in autonomous tractors and will allow such tractors to back into a trailer 20 and automatically connect the electrical, pneumatic, and other connections without the need for any human intervention.

In some examples, the auto-coupling system has a simple and quick installation process that involves only a few steps for mounting the base 112 between the vehicle frame and the fifth wheel, and may not involve any modifications to the trailer 20. Thus, the auto-coupling system 100 may work with an existing fifth wheel of a towing vehicle and is compatible with most trailers.

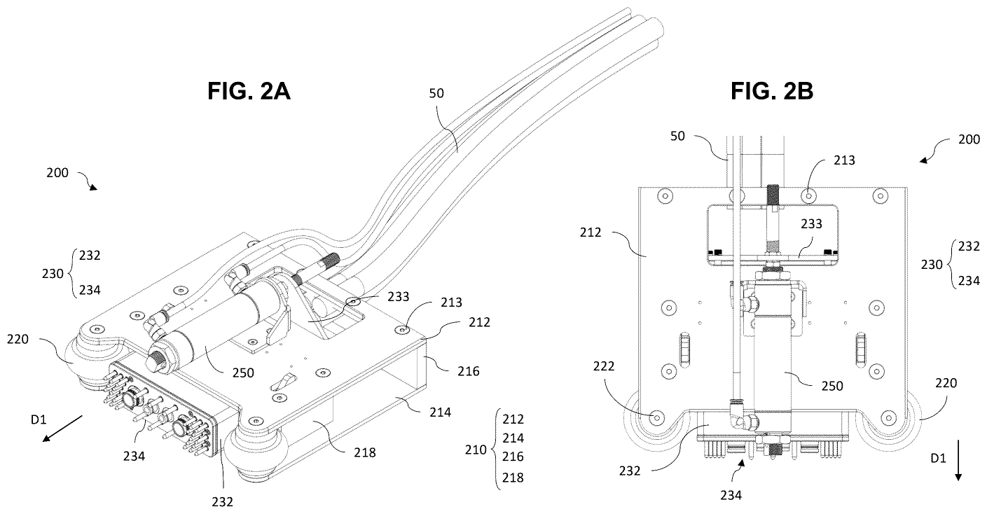

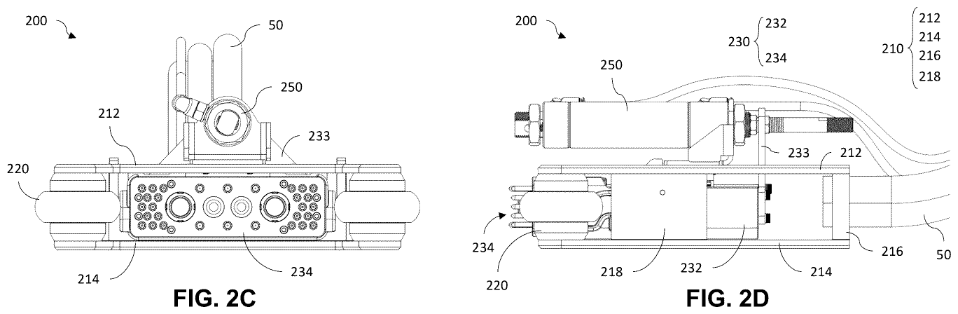

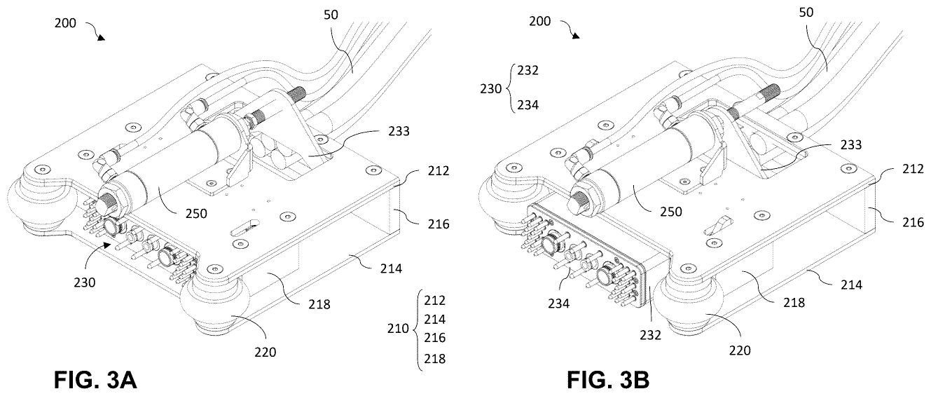

FIGS. 2A, 2B, 2C, and 2D respectively illustrate a perspective view, a top view, a front view, and a side view of the fine-alignment coupling system 200, according to some example embodiments of the present disclosure. FIGS. 3A and 3B respectively illustrate the fine-alignment coupling system 200 in a disengaged state and an engaged state, according to some example embodiments of the present disclosure.

Referring to FIGS. 2A-2D, in some embodiments, the fine-alignment coupling system 200 includes a housing 210, one or more (e.g., a pair of) alignment wheels 220, a moveable connector carriage 230, and an actuator 250.

In some embodiments, the housing 210 includes a first plate (e.g., a top plate) 212 and a second plate (e.g., a bottom plate) 214 that are parallel to one another and separated via a back plate 216 and side panels 218. The first and second plates 212 and 214 may be affixed to the back plate 216 and the side panels 218 via fasteners (e.g., screws, rivets, nuts and bolts, etc.) 213 or any other suitable fixing mechanism or process, such as welding and/or the like. The first and second plates 212 and 214 and the back plate 216 define an accommodation space therebetween which can accommodate the connector carriage 230. The back plate 216 may have an opening to allow the first electrical and pneumatic conduits 50 to pass therethrough and couple to the connector carriage 230. As shown in FIGS. 2A and 2D, the side panels 218 may be positioned to be inwardly offset relative to the exterior sides of the housing 210 and may only partially cover the sides of the connector carriage 230. However, this is merely an example, and the side panels 218 may extend horizontally to cover any portion of the sides of the connector carriage 230. Further, the structure of the housing 210 shown in FIGS. 2A-2D and described herein is merely an example, and embodiments of the present disclosure are not limited thereto. For example, the housing 210 may have an integrated and monolithic construction, or be made of any suitable number of components having any suitable shapes.

According to some embodiments, the alignment wheels 220 facilitate the movement of the fine-alignment coupling system 200 against the guide track 42 and toward the second connector head 30 of the trailer 20. In some embodiments, each of the alignment wheels 220 is coupled to the housing 210, for example, between the first and second plates 212 and 214, at the two front corners of the housing 210 facing the trailer 20 (also referred to as the first and second corners the housing 210). Each of the alignment wheels 220 may be rotatably mounted to the housing 210 via a wheel axle 222. While FIGS. 2A-2D illustrate the use of a pair of wheels 220, embodiments of the present disclosure are not limited thereto, and any suitable number of wheels, skids, rollers or other locating apparatus, may be utilized to allow the fine-alignment coupling system 200 to roll or slide across the front of the trailer 20 (e.g., ride along the guide track 42 at the trailer front).

In some embodiments, the connector carriage 230 fits within the housing 210 and is configured to move back and forth, relative to the housing 210, along a first direction D1, which may be the longitudinal direction of the connector carriage 230. The connector carriage 230 may include a carriage body 232 and a first connector head 240, which is configured to mate with the second connector head 30 at the trailer 20 and to establish an electrical and pneumatic connection between the towing vehicle and the trailer 20.

The movement of the connector carriage 230 is facilitated by the actuator 250, which is fixedly connected to the housing 210 (e.g., to the first plate 212) and pushes or pulls against the carriage body 232 (e.g., a protruding portion 233 of the carriage body 232) based on an input. In some embodiments, the actuator 250 is a linear actuator that is pneumatically activated. The actuator 250 may have an internal chamber configured to receive, and to expand in response to, pressurized air from the towing vehicle, and may include a piston configured to apply a force to the carriage body 232 (e.g., the protruding portion 233 of the carriage body 232) to move the connector carriage 230 in the first direction D1 in response to expansion of the internal chamber.

In some embodiments, the actuator 250 receives pressurized air that is syphoned off of the pneumatic brake system of the towing vehicle (e.g., by branching off of the pneumatic hose to feed the actuator 250). When the fifth wheel 10 of the towing vehicle clamps around the kingpin of the trailer 20, a sensor at the towing vehicle senses the connection and pressurizes the parking brake line at the towing vehicle. This released pressure activates the actuator 250, causing the connector carriage 230 to move towards the trailer and engage and mate with the second connector header 30 of the trailer 20. The operation of the actuator 250 and its ability to move the connector carriage 230 to engage and disengage with the second connector head 30 of the trailer 20 is shown in FIGS. 3A and 3B, respectively.

When the fifth wheel 10 of the towing vehicle is disconnected from the kingpin of the trailer 20 (i.e., when the towing vehicle and trailer 20 are disconnected), the towing vehicle senses the disconnection and shuts off air pressure on the pneumatic lines. This causes the actuator 250 to deactivate and disengage/retract the connector carriage 230 back into the housing 210. This retraction reduces the likelihood of damage to the terminals of the first connector head 234 by, for example, preventing the terminals from scrapping against the guide track 42 during subsequent coupling maneuvers.

In some examples, the actuator 250 may be a single-acting actuator that uses air pressure to move the piston in one direction, and relies on a spring or other mechanism to return it to the starting position (as shown in FIGS. 2A-2D), allowing for movement in both direction.

While the actuator 250 illustrated in FIGS. 2A-2D and described above is pneumatic, embodiments of the present disclosure are not limited thereto. For example, the actuator 250 may be a linear actuator of any suitable type that can extend or compress in response to an electrical control signal.

During the coupling/uncoupling process, the auto-coupling system 100 may frequently experience large forces with the potentiality of damage to the various electrical and data terminals, as well as the pneumatic fittings. Further, the spring tension of the course-alignment coupling system may be insufficient to keep the connectors in-place while the vehicle is moving. To mitigate these issues, the fine-alignment coupling system 200 employs a multi-stage alignment and locking/unlocking mechanism. This mechanism does not require input by the vehicle operator and automatically engages/disengages (i.e., locks/unlocks) when the tractor-trailer kingpin engages/disengages with the fifth wheel. The actuator 250 is configured to either extend or compress, depending on whether coupling or uncoupling has occurred, engaging the locking mechanism on the connector carriage 230.

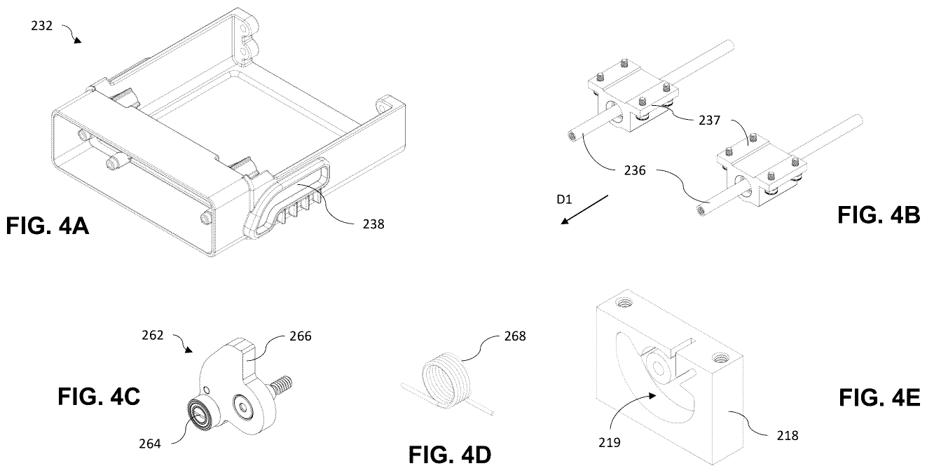

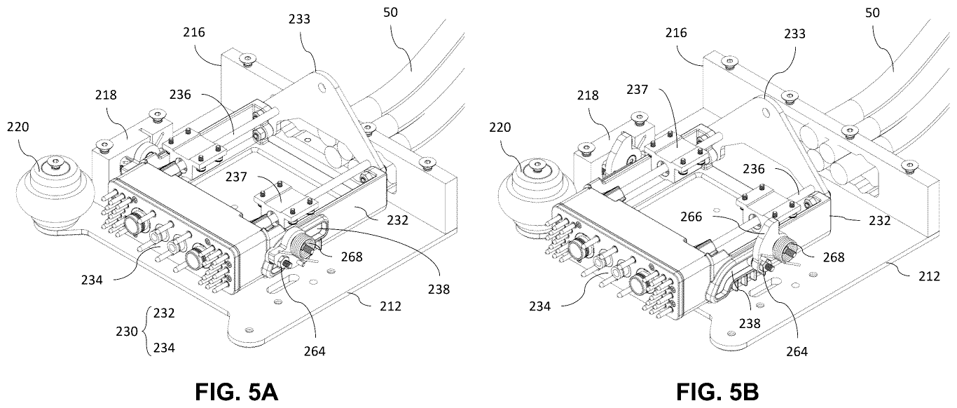

The operation and the constituent components of the locking mechanism are described further below with respect to FIGS. 4A-4E and FIG. 5A-5B.

FIGS. 4A, 4B, and 4C illustrate various components of the sliding mechanism of the connector carriage 230, according to some embodiments of the present disclosure. FIG. 4A illustrates a partial perspective view of the carriage body 232, and FIG. 4B illustrates a perspective view of the sliding mechanism of the fine-alignment coupling system 200, according to some embodiments of the present disclosure. FIGS. 4C, 4D, and 4E respectively illustrate perspective views of a lock lever 262 of the locking mechanism 260, a spring 268 of the locking mechanism 260, and a side panel 218 of the housing 210, according to some embodiments of the present disclosure. FIGS. 5A and 5B illustrate perspective exposed views of the connector carriage 230 in a disengaged/unlocked position and in an engaged/locked position, respectively, according to some embodiments of the present disclosure.

Referring to FIGS. 4A and 4B, the connector carriage 230 includes one or more (e.g., a pair of) slide rails 236 that are longitudinally attached to the carriage body 232, and one or more (e.g., a pair of) linear slide bearings 237 that are fixedly attached to the housing 210 (e.g., to the underside of the first plate 212). The one or more slide rails 236 pass through the one or more slide bearings 237 and together allow for the linear motion of the connector carriage 230 along the first direction within the housing 210. The carriage body 232 also includes slide tracks 238 defined at its sides that engage the lock lever 262 of the locking mechanism 260. The slide track 238 may have a linear portion and a downward sloping portion as shown in FIG. 4A. As shown in FIGS. 4C-4E, the lock lever 262 has a slide follower 264, which may be in the form of a cylindrical protrusion, that fits within and travels along the slide track 238 of the carriage body 232. The lock lever 262 also includes a protrusion (e.g., a cam) 266 that can engage an opening in the housing 210 and locks the connector carriage 230 to the housing 210 (see, e.g., FIG. 3B). The lock lever 262 is rotatably anchored to the side panel 218 at a point that is offset from the slide follower 264. The connection between the lock lever 262 and the side panel 218 may be spring-loaded via the spring 268 that fits within a groove 219 of the side panel.

As shown in FIG. 5A, when the connector carriage 230 is in the disengaged/retreated state, the position of the slide follower 264 along the slide track 238 is such that it forces the protrusion 266 of the lock lever 262 down, and when the connector carriage 230 is in the engaged/forward state, the vertical position of the slide follower 264 along the slide track 238 changes to force the protrusion 266 of the lock lever 262 upward to pass through an opening in the housing 210 and lock the position of the connector carriage 230 relative to the housing. The locking action performed by the locking mechanism 260 occurs automatically in response to a set displacement of the connector carriage 230 relative to the housing 210, and thus does not require any human intervention. When the connector carriage 230 is not in the lock position, the spring-biasing of the lock lever 262 ensures that it retracted, allowing for movement of the connector carriage 230 via the actuator 250.

While FIGS. 4A-4E and FIG. 5A-5B illustrate a single-cam locking mechanism on each side of the connector carriage 230, embodiments of the present disclosure are not limited thereto, and any suitable locking mechanism may be utilized. For example, the locking mechanism 260 may have a double-cam structure that locks into both the first and second plates 212 and 214 of the housing 210.

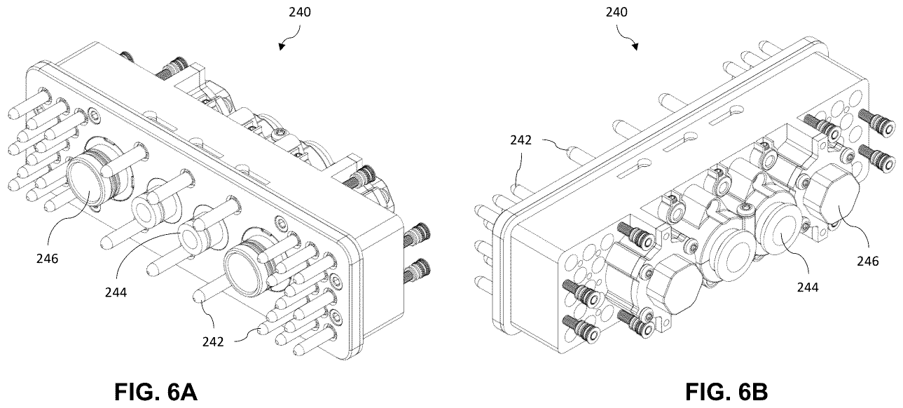

FIGS. 6A and 6B illustrate a front side perspective view and a rear side perspective view of the a first connector head 240, according to some embodiments of the present disclosure.

In some embodiments, the first connector head 240 includes a plurality of electrical connection terminals 242 and one or more pneumatic terminals 244.

The electrical connection terminals (e.g., male electrical pins/terminals) 242 are configured to mate with and electrically connect to corresponding terminals (e.g., female electrical terminals) of the second connector head 30 of the trailer 20, and are further connected to the electrical system of the towing vehicle via the electrical connectors/lines of the first electrical and pneumatic conduits 50. When the first connector head 240 is mated with the second connector head 30 of the trailer 20, the electrical connection terminals 242 may provide the signals commonly provided as part of the SAE J560 interface (e.g., +12 V, ground, brake signal, left and right turn signals, etc.) to the electrical system of the trailer 20 (e.g., to the brake and tail lights at the trailer 20) and allow for other data signals to be transmitted back and forth between the towing vehicle and the trailer 20.

The one or more pneumatic terminals (e.g., pneumatic fittings) 244, which may be in the form of one or more tubular protrusions, are connected to the pneumatic hoses/lines of the first electrical and pneumatic conduits 50 and primarily provide pressurized air to power the trailer's brakes and other air-operated systems. For example, when the first connector head 240 is mated with the second connector head 30 of the trailer 20, a pair of pneumatic terminals 244 may enable the transmission of air for both emergency (supply line) and service (control line) braking functions. The service/control line may transmit air pressure from the towing vehicle's brakes to the trailer 20, allowing the driver to control the trailer's brake, and the emergency/supply line supplies air at full tractor pressure to the trailer's tanks and activates the trailer's emergency brakes if the connection is severed or air pressure drops.

The pneumatic terminals 244 may include one-way check valves therein that prevent the release of pressure to the atmosphere and prevent the ingress of dirt/debris into the pneumatic system of the towing vehicle, and only release air pressure once the pneumatic terminals 244 are mated with the corresponding connectors at the second connector head 30 of the trailer 20. Similarly, the pneumatic connectors on the trailer side may also include one-way check valves to prevent ingress of dust/debris into the trailer pneumatic system.

According to some embodiments, the electrical connection terminals 242 are pins having conical ends which extend past the pneumatic fittings 244. The shape and length of pins 242 may allow the first connector head 234 to achieve very fine alignment with the second connector head 30 of the trailer 20.

In some embodiments, the first connector head 240 may also include one or more ethernet terminals 246 configured to establish ethernet connection with high-throughput between the towing vehicle and the trailer 20.

As described above, the auto-coupling system 100 enables the automatic alignment and connection of electrical, pneumatic, and other interfaces between a towing vehicle and a trailer without the need for human intervention. By automating the alignment and connection processes, the described system reduces the time and effort required for coupling, minimizes the risk of human error, and enhances compatibility with autonomous vehicle systems that need to perform coupling maneuvers without operator assistance.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The present invention is not to be limited in scope by the specific embodiments described herein. Indeed, other various embodiments of and modifications to the present invention, in addition to those described herein, may be apparent to those of ordinary skill in the art from the foregoing description and accompanying drawings. Thus, such other embodiments and modifications are intended to fall within the scope of the present invention. Further, although the present invention has been described herein in the context of a particular implementation in a particular environment for a particular purpose, those of ordinary skill in the art may recognize that its usefulness is not limited thereto and that the present invention may be beneficially implemented in any number of environments for any number of purposes. Accordingly, the claims set forth below should be construed in view of the full breadth and spirit of the present invention as described herein.

What is claimed is:

1. A fine-alignment coupling system for coupling a trailer and a towing vehicle, the fine-alignment coupling system comprising:
a housing comprising a first plate and a second plate coupled to one another;
a connector carriage within the housing and configured to move relative to the housing along a first direction, the connector carriage comprising:
a first connector head comprising a plurality of electrical connection terminals and a pneumatic terminal; and
an actuator fixedly coupled to the housing and configured to move the connector carriage relative to the housing along the first direction.

2. The fine-alignment coupling system of claim 1, wherein the housing is coupled to an arm of a coarse-alignment coupling system of the towing vehicle.

3. The fine-alignment coupling system of claim 1, wherein the first and second plates of the housing are parallel to one another and define an accommodation space therebetween configured to accommodate the connector carriage, and
wherein the first and second plates are fixedly connected to a backplate and sidewalls of the housing via a plurality of fasteners.

4. The fine-alignment coupling system of claim 1, wherein the connector carriage comprises a slide rail attached to a body of the connector carriage and a linear slide bearing coupled to the housing, and
wherein the slide rail is configured to slide through the linear slide bearing and to enable linear motion of the connector carriage within the housing.

5. The fine-alignment coupling system of claim 1, wherein the first connector head is configured to mate with a second connector head at the trailer and to establish an electrical and pneumatic connection between the towing vehicle and the trailer.

6. The fine-alignment coupling system of claim 1, wherein the first connector head further comprises:
An ethernet terminal configured to establish ethernet connection between the towing vehicle and the trailer.

7. The fine-alignment coupling system of claim 1, wherein the plurality of electrical connection terminals are connected to an electrical connector from the towing vehicle, and
wherein the pneumatic terminal is connected to a pneumatic hose from the towing vehicle.

8. The fine-alignment coupling system of claim 1, further comprising a locking mechanism configured to lock the connector carriage to the housing at a lock position in response to a set displacement of the connector carriage relative to the housing.

9. The fine-alignment coupling system of claim 8, wherein the locking mechanism comprises a lock lever that is spring-loaded to be retracted in response to the connector carriage not being in the lock position, and
wherein the lock lever is configured to engage an opening in the housing in response to the set displacement of the connector carriage relative to the housing.

10. The fine-alignment coupling system of claim 9, wherein the connector carriage comprises a sliding track extending along a sidewall of the connector carriage, and
wherein the locking mechanism comprises a slide follower coupled to the lock lever and configured to move along the sliding track.

11. The fine-alignment coupling system of claim 1, wherein the actuator is linear actuator that is pneumatically activated.

12. The fine-alignment coupling system of claim 1, wherein the actuator has an internal chamber configured to receive, and to expand in response to, pressurized air from the towing vehicle, and
wherein the actuator further comprises a piston configured to apply a force to a back plate of the connector carriage to move the connector carriage in the first direction in response to expansion of the internal chamber.

13. The fine-alignment coupling system of claim 1, further comprising:
a first alignment wheel rotatably coupled between the first and second plates and configured to roll against a guide track at a front surface of the trailer facing the towing vehicle.

14. The fine-alignment coupling system of claim 13, further comprising:
a second alignment wheel rotatably coupled between the first and second plates at of the housing and configured to roll against the guide track, and
wherein the first and second alignment wheels are at a first corner and a second corner of the housing, respectively.

15. An auto-coupling system comprising:
a coarse-alignment coupling system coupled to a towing vehicle and comprising:
a base mounted to a fifth wheel of the towing vehicle or a vehicle frame under the fifth wheel of the towing vehicle; and
a moveable arm movably coupled to the base; and
a fine-alignment coupling system coupled to an end of the moveable arm and comprising:
a housing comprising a first plate and a second plate coupled to one another;
a connector carriage within the housing and configured to move relative to the housing along a first direction, the connector carriage comprising:
a first connector head comprising a plurality of electrical connection terminals and a pneumatic terminal; and
an actuator fixedly coupled to the housing and configured to move the connector carriage relative to the housing along the first direction.

16. The auto-coupling system of claim 15, wherein, in response to the towing vehicle performing a coupling maneuver with a trailer,
the coarse-alignment coupling system is configured to bring the fine-alignment coupling system in close proximity to a second connector head of the trailer, and
the fine-alignment coupling system is configured to bring the first connector head in contact with the second connector head.

17. The auto-coupling system of claim 16, wherein the first connector head is connected to first electrical and pneumatic conduits from the towing vehicle, and the second connector head is connected to second electrical and pneumatic conduits of the trailer.

18. The auto-coupling system of claim 16, wherein the fine-alignment coupling system further comprises:
a first alignment wheel rotatably coupled between the first and second plates and configured to roll against a sliding track at a front surface of the trailer facing the towing vehicle.

19. The auto-coupling system of claim 15, wherein the plurality of electrical connection terminals are connected to an electrical connector from the towing vehicle, and
wherein the pneumatic terminal is connected to a pneumatic hose from the towing vehicle.

20. The auto-coupling system of claim 15, wherein the fine-alignment coupling system further comprises:
a locking mechanism configured to lock the connector carriage to the housing at a lock position in response to a set displacement of the connector carriage relative to the housing.
